(19) United States
(12) Patent Application Publication
(10) Pub. No.: US 2019/0064011 A1
(43) Pub. Date: Feb. 28, 2019

(54) FLEXIBLE SENSOR

(71) Applicant: National Tsing Hua University, Hsinchu City (TW)

(72) Inventors: Jhih-Jhe Wang, Hsinchu City (TW); Wei-Leun Fang, Hsinchu City (TW)

(73) Assignee: National Tsing Hua University, Hsinchu City (TW)

(21) Appl. No.: 15/785,444

(22) Filed: Oct. 17, 2017

(30) Foreign Application Priority Data
Aug. 28, 2017 (TW) 106129205

(51) Int. Cl. G01L 1/22

(52) U.S. Cl. CPC G01L 1/2287

(57) ABSTRACT

A flexible sensor including a polymer substrate, four polymer sensor units, a polymer bump, and a plurality of conductive patterns is provided. The polymeric sensor units are embedded in the polymer substrate, wherein one pair of the polymer sensor units are located at two opposite sides of the polymer substrate in a first direction, and the other pair of the polymer sensor units are located at two opposite sides of the polymer substrate in a second direction perpendicular to the first direction. The polymer bump is disposed on the polymer substrate and covers the four polymer sensor units. The conductive patterns are disposed on the polymer substrate and respectively connected to the corresponding polymer sensor unit.

### CROSS-REFERENCE TO RELATED APPLICATION

This application claims the priority benefit of Taiwan application serial no. 106129205, filed on Aug. 28, 2017. The entirety of the above-mentioned patent application is hereby incorporated by reference herein and made a part of this specification.

### BACKGROUND OF THE INVENTION

### Field of the Invention

The invention relates to a sensor, and more particularly, to a flexible sensor.

### Description of Related Art

In recent years, various types of tactile sensors have been developed and applied in fields such as consumer electronic devices, machine devices, or prosthetics. For the applications above, flexible or piezoresistive sensors that can be attached to human skin have also been rapidly developed and applied in foldable, deformable, bendable, stretchable, and wearable devices.

Tactile sensors sense strain triggered by pressure and analyze the strength of the force and the location of the applied force in order to analyze the distribution and situation of the force with the measured results.

Currently, piezoresistive sensors having a large area and flexibility have been rapidly developed and are integrated and applied on artificial electronic skin to detect the strength and location of the pressure on the surface thereof. Therefore, how to effectively and accurately sense the strength and location of the pressure is a very important topic in the development of piezoresistive sensors.

### SUMMARY OF THE INVENTION

The invention provides a flexible sensor having polymer sensor units at the sides of a polymer substrate.

A flexible sensor of the invention includes a polymer substrate, four polymer sensor units, a polymer bump, and a plurality of conductive patterns. The polymeric sensor units are embedded in the polymer substrate, wherein one pair of the polymer sensor units are located at two opposite sides of the polymer substrate in a first direction, and the other pair of the polymer sensor units are located at two opposite sides of the polymer substrate in a second direction perpendicular to the first direction. The polymer bump is disposed on the polymer substrate and covers the four polymer sensor units. The conductive patterns are disposed on the polymer substrate and respectively connected to the corresponding polymer sensor unit.

In an embodiment of the flexible sensor of the invention, the material of the polymer substrate is, for instance, rubber, plastic, or a combination thereof.

In an embodiment of the flexible sensor of the invention, the material of the polymer sensor units is, for instance, rubber, plastic, or a combination thereof, and contains conductive particles.

In an embodiment of the flexible sensor of the invention, the material of the conductive particles is, for instance, carbon black, metal, doped silicon, graphene, conductive polymer material, or a combination thereof.

In an embodiment of the flexible sensor of the invention, the conductive particles are, for instance, spherical conductive particles.

In an embodiment of the flexible sensor of the invention, the material of the polymer bump is, for instance, rubber, plastic, metal, silicon, or a combination thereof.

In an embodiment of the flexible sensor of the invention, the material of the polymer substrate, the material of the polymer sensor units, and the material of the polymer bump are, for instance, the same.

In an embodiment of the flexible sensor of the invention, the material of the conductive patterns is, for instance, metal, conductive polymer material, or a combination thereof.

In an embodiment of the flexible sensor of the invention, the polymer sensor unit has, for instance, a bent shape or a rectangular shape.

In an embodiment of the flexible sensor of the invention, the polymer substrate exposes the upper surfaces of the polymer sensor units.

Based on the above, in the invention, four sensor units are each disposed at four sides adjacent to the polymer substrate and the sensor units are formed by a polymer material containing conductive particles, and therefore the flexible sensor can easily and accurately sense an external force in three axes (X direction, Y direction, and Z direction) and can have better sensitivity. Moreover, since the entire flexible sensor of the invention is formed by a polymer material, the flexible sensor has characteristics such as lightweight, softness, and good flexibility.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of a flexible sensor according to an embodiment of the invention.

FIG. 2 is a cross section shown along section line I-I in FIG. 1.

FIG. 3 is a cross section of the flexible sensor of FIG. 1 subjected to a normal force.

FIG. 4 is a cross section of the flexible sensor of FIG. 1 subjected to a shear force.

### DESCRIPTION OF THE EMBODIMENTS

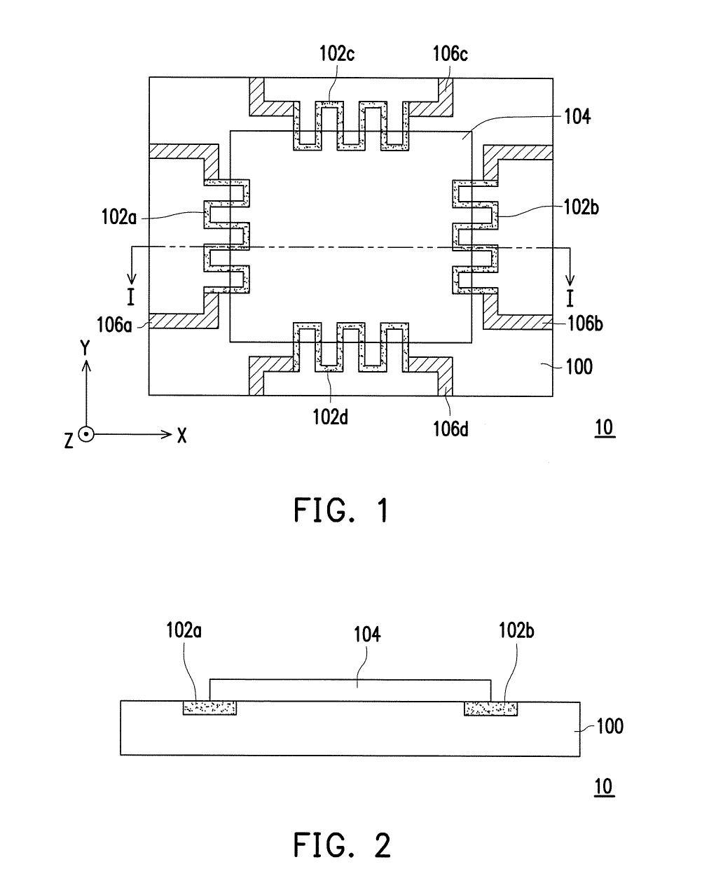

FIG. 1 is a top view of a flexible sensor according to an embodiment of the invention. FIG. 2 is a cross section shown along section line I-I in FIG. 1. Referring to both FIG. 1 and FIG. 2, a flexible sensor 10 includes a polymer substrate 100, polymer sensor units 102a, 102b, 102c, and 102d, a polymer bump 104, and conductive patterns 106a, 106b, 106c, and 106d.

The polymer substrate 100 is used to carry sensor units. The material of the polymer substrate 100 is, for instance, rubber, plastic, or a combination thereof, such that the polymer substrate 100 has flexibility. Since the polymer substrate 100 has flexibility, forces from all directions (such as normal force and shear force) can be tolerated, and deformation can occur without damage. In the present embodiment, the polymer substrate 100 is a rectangular substrate, but the invention is not limited thereto. In other embodiments, substrates of other shapes can be used based on actual application requirements.

The polymer sensor units 102a, 102b, 102c, and 102d are embedded in the polymer substrate 100. In the present embodiment, the polymer substrate 100 exposes the upper surfaces of the polymer sensor units 102a, 102b, 102c, and 102d. The material of the polymer sensor units 102a, 102b, 102c, and 102d is, for instance, rubber, plastic, or a combination thereof, and contains a conductive particle. The conductive particles are uniformly dispersed in each of the polymer sensor units. Since the polymer sensor units 102a, 102b, 102c, and 102d have flexibility, forces from all directions can be tolerated, and deformation can occur without damage. Moreover, when the polymer sensor units are deformed, the distance between the conductive particles is changed, such that resistivity is changed, and the strength of the force tolerated can be analyzed by measuring the change in resistivity. The material of the conductive particles is, for instance, carbon black, metal, doped silicon, graphene, conductive polymer material, or a combination thereof.

The conductive particles are preferably spherical conductive particles. In the case that the polymer sensor units contain spherical conductive particles, when the polymer sensor units are deformed, the spatial distribution and contact state between the spherical conductive particles can be more simply and easily changed such that the resistance is significantly changed such that the polymer sensor units can have higher sensitivity.

In the present embodiment, the polymer sensor units 102a, 102b, 102c, and 102d are each disposed adjacent to four sides of the polymer substrate 100. Specifically, the polymer sensor units 102a and 102b are respectively located at two opposite sides (left side and right side in FIG. 1) of the polymer substrate 100 in the first direction (X direction), and the polymer sensor units 102c and 102d are respectively located at two opposite sides (upper side and lower side in FIG. 1) of the polymer substrate 100 in the second direction (Y direction). In the present embodiment, the polymer sensor units 102a, 102b, 102c, and 102d are disposed adjacent to four sides of the polymer substrate 100, and therefore forces from all directions can be effectively sensed in the XY plane and Z plane. Moreover, the shape of the polymer sensor units 102a, 102b, 102c, and 102d can affect the degree of normal force and shear force tolerated by the sensor units. In the present embodiment, the polymer sensor units 102a, 102b, 102c, and 102d each have a bent shape. The effects of the bent shape are described later.

The polymer bump 104 is disposed on the polymer substrate 100 and covers the polymer sensor units 102a, 102b, 102c, and 102d. The material of the polymer bump 104 is, for instance, rubber, plastic, metal, silicon, or a combination thereof. The polymer bump 104 is used as a contact pad of the flexible sensor 10 receiving an applied force, i.e., external forces (normal force and shear force) are all applied to the polymer bump 104. In the present embodiment, the polymer bump 104 covers a portion of each of the polymer sensor units, but the invention is not limited thereto. In other embodiments, the polymer bump 104 can also cover the entire polymer sensor unit.

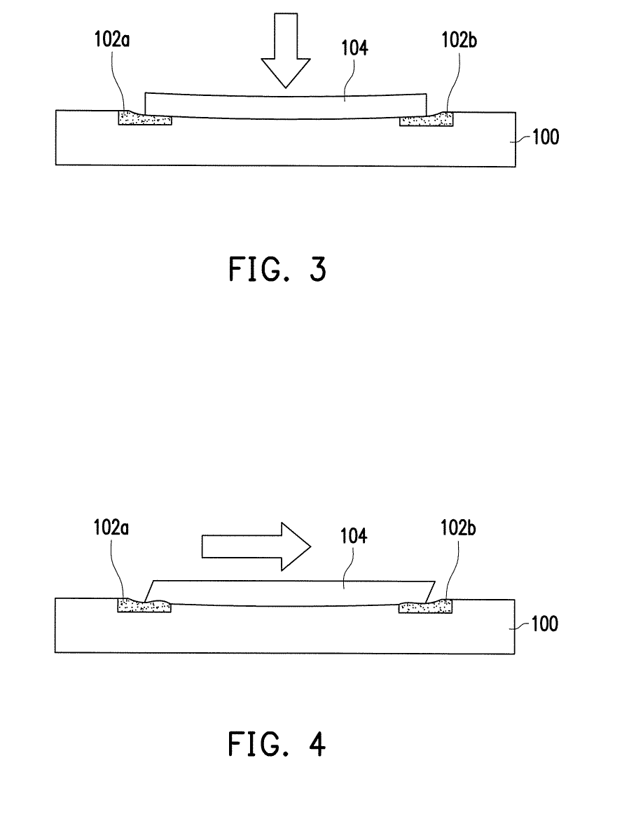

When a normal force is applied to the polymer bump 104 in the Z direction, the normal force can be transferred to the polymer sensor units 102a, 102b, 102c, and 102d via the polymer bump 104 and deform the polymer sensor units 102a, 102b, 102c, and 102d as shown in FIG. 3. When a shear force is applied to the polymer bump 104 in a direction perpendicular to the Z direction, the shear force can be transferred to the polymer sensor units 102a, 102b, 102c, and 102d via the polymer bump 104 and the polymer sensor units 102a, 102b, 102c, and 102d can be deformed as shown in FIG. 4.

Moreover, based on the direction of the shear force, the polymer sensor units 102a, 102b, 102c, and 102d respectively at different locations are subjected to different degrees of force. For instance, since the polymer sensor units 102a, 102b, 102c, and 102d are disposed adjacent to four sides of the polymer substrate 100, when shear force is applied in the X direction, the polymer sensor units 102a and 102b are deformed to a greater degree, and the polymer sensor units 102c and 102d are deformed to a lesser degree. As a result, via the change of the resistance of each of the polymer sensor units 102a, 102b, 102c, and 102d, the magnitude and direction of the shear force applied can be easily and accurately analyzed.

As shown in FIG. 1, the polymer sensor units 102a, 102b, 102c, and 102d each have a 5-fold bent shape pattern, but the invention is not limited thereto. In other embodiments, the polymer sensor units 102a, 102b, 102c, and 102d can also each have a rectangular shape. In the case of the polymer sensor units 102a and 102b in the X direction, when a shear force is applied in the X direction, in comparison to the polymer sensor units 102c and 102d, the polymer sensor units 102a and 102b can have more significantly-deformed portions in the X direction, and the polymer sensor units 102a and 102b each have different degrees of deformation, and therefore the difference in resistance change of the sensor units (the polymer sensor units 102a and 102b) in the X direction and the difference in resistance change of the sensor units (the polymer sensor units 102c and 102d) in the Y direction can be clearly distinguished. Similarly, when a shear force is applied in the Y direction, the difference in resistance change of the sensor units can also be clearly distinguished.

The conductive patterns 106a, 106b, 106c, and 106d are disposed on the polymer substrate 100 and respectively connected to the corresponding polymer sensor unit. The material of the conductive patterns 106a, 106b, 106c, and 106d is, for instance, metal. In the present embodiment, the conductive pattern 106a is connected to the polymer sensor unit 102a, the conductive pattern 106b is connected to the polymer sensor unit 102b, the conductive pattern 106c is connected to the polymer sensor unit 102c, and the conductive pattern 106d is connected to the polymer sensor unit 102d. Moreover, the conductive patterns 106a, 106b, 106c, and 106d can be connected to an external device to further analyze the received electrical signal. The connection method of the conductive patterns 106a, 106b, 106c, and 106d and the corresponding polymer sensor units is not particularly limited in the invention. When the polymer sensor units 102a, 102b, 102c, and 102d sense an external force and are deformed such that resistance is changed, an external device can rapidly learn the amount of change of the resistance via an electrical signal sent by the conductive patterns 106a, 106b, 106c, and 106d and analyze related information of the external force.

In the present embodiment, the flexible sensor 10 can easily and accurately sense and analyze the external force in the X direction, Y direction, and Z direction. Moreover, since the sensing units are formed by a polymer material containing a conductive particle and has a structural pattern design, the sensor units have better sensitivity. Moreover, since the entire flexible sensor 10 is formed by a polymer material, the flexible sensor 10 has characteristics such as lightweight, softness, and good flexibility. In other words, the flexible sensor 10 is a flexible three-axis tactile sensor and can effectively be applied in a technical field requiring force sensing such as human skin attachment, robots, and prosthetics.

To make the flexible sensor 10 not readily damaged when subjected to an external force, i.e., have better mechanical properties, the polymer substrate 100, the polymer sensor units 102a, 102b, 102c, and 102d, and the polymer bump 104 preferably all adopt rubber as the material. As a result, the resulting polymer substrate 100, the polymer sensor units 102a, 102b, 102c, and 102d, and the polymer bump 104 are integrally bonded and do not have interface borders, and therefore the polymer substrate 100, the polymer sensor units 102a, 102b, 102c, and 102d, and the polymer bump 104 are integrally formed and have better bonding and are not readily separated as a result.

In the following, the manufacture of the flexible sensor 10 is described.

First, 30 wt % of nano carbon black spherical powder and a polydimethylsiloxane (PDMS) material were respectively mixed with an n-hexane solution for 2 hours. Next, the mixed solution of nano carbon black powder and n-hexane and the mixed solution of dimethylsiloxane material and n-hexane were mixed for 1 hour. Next, the resulting mixed solution was heated throughout the night such that the solvent (n-hexane) was completely volatilized to obtain a nano composite polymer. Next, a curing agent was added to the nano composite polymer (mixing ratio: 10:1) to obtain a C-PDMS nano composite material.

Next, an anti-stick layer (perfluorooctyltrichlorosilane (PFOTS)) was deposited on a silicon wafer. Next, a first mask layer was formed on the anti-stick layer. Next, the C-PDMS nano composite material was formed on the silicon wafer exposed by the first mask layer in a screen printing method. Next, the first mask layer was removed. Next, the PDMS material was formed on the silicon wafer to cover the C-PDMS nano composite material. Next, the silicon wafer was removed. Next, a 3-mercaptopropyltrimethoxysilane (MPTMS) monomolecular layer and a gold film were deposited on the PDMS material via a second mask layer using an evaporation method to define a conductive pattern used as the electrode. Next, a PDMS bump was bonded on the PDMS material using a plasma surface treatment to complete the flexible sensor shown in FIG. 1.

In the manufacturing process above, the same polymer material is used to form the substrate, sensor unit, and bump of the flexible sensor, and therefore the resulting flexible sensor is not readily damaged when subjected to external force and has high elasticity and high deformability. Moreover, it can be known from the manufacturing method above that, the semiconductor wafer-level large area manufacturing mold forming can be applied in the manufacture of the flexible sensor of the invention.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A flexible sensor, comprising:
a polymer substrate;
four polymer sensor units embedded in the polymer substrate, wherein one pair of the polymer sensor units are located at two opposite sides of the polymer substrate in a first direction, and the other pair of the polymer sensor units are located at two opposite sides of the polymer substrate in a second direction perpendicular to the first direction;
a polymer bump disposed on the polymer substrate and covering the four polymer sensor units; and
a plurality of conductive patterns disposed on the polymer substrate and respectively connected to the corresponding polymer sensor unit.

2. The flexible sensor of claim 1, wherein a material of the polymer substrate comprises a rubber, a plastic, or a combination thereof.

3. The flexible sensor of claim 1, wherein a material of the polymer sensor units comprises a rubber, a plastic, or a combination thereof, and contains conductive particles.

4. The flexible sensor of claim 3, wherein a material of the conductive particles comprises a carbon black, a metal, a doped silicon, a graphene, a conductive polymer material, or a combination thereof.

5. The flexible sensor of claim 3, wherein the conductive particles are spherical conductive particles.

6. The flexible sensor of claim 1, wherein a material of the polymer bump comprises a rubber, a plastic, a metal, a silicon, or a combination thereof.

7. The flexible sensor of claim 1, wherein a material of the polymer substrate, a material of the polymer sensor units, and a material of the polymer bump are the same.

8. The flexible sensor of claim 1, wherein a material of the conductive patterns comprises a metal, a conductive polymer material, or a combination thereof.

9. The flexible sensor of claim 1, wherein the polymer sensor unit has a bent shape or a rectangular shape.

10. The flexible sensor of claim 1, wherein the polymer substrate exposes upper surfaces of the polymer sensor units.
